(19) United States
(12) Patent Application Publication
(10) Pub. No.: US 2005/0116811 A1
(43) Pub. Date: Jun. 2, 2005

(54) Method for detecting the position and for confirming the identity of an individual

(76) Inventors: Masi Eros, Castiglioncello Li (IT); Paglialunga Vincenzo, Galatina Le (IT)

Correspondence Address: DENNISON, SCHULTZ, DOUGHERTY & MACDONALD, 1727 KING STREET, SUITE 105, ALEXANDRIA, VA, 22314, US

(21) Appl. No.: 10/505,162

(22) PCT Filed: Mar. 5, 2003
(86) PCT No.: PCT/IB03/00811

(30) Foreign Application Priority Data
Mar. 5, 2002 (IT) PI2002A000012

(51) Int. Cl. G07C 9/00

(52) U.S. Cl. 340/5.82; 340/5.61; 340/10.41; 340/539.13; 340/573.1

(57) ABSTRACT

A method and a device for testing the presence and verifying the identity of an individual at the receipt, by a bracelet that the individual wears, of a verification signal sent by a central computer unit. The device has a central portion including means for receiving the verification signal, and means for controlling biometric data and for transmitting data of presence. The bracelet is secured to the wrist or to the ankle of the individual by means of a belt, or wristlet, equipped with a closure that can be locked or freely releasable, depending on the individual to be guarded. When requested, the individual that wears the bracelet on a first arm receives a verification signal sent by the central unit and places a predetermined finger of the second hand on the means of detecting a fingerprint located on the bracelet. This enables the central unit to verify the identity and the position of the individual.

### FIELD OF THE INVENTION

The present invention relates to a method for measuring the presence of an individual in a predetermined area and for checking at the same time the identity, in particular for individuals with restriction of freedom, such as individuals confined within a pre-designated location, individuals under police surveillance, patients affected by dangerous infective pathologies etc.

The invention relates also to a device that carries out this method.

### DESCRIPTION OF THE PRIOR ART

As known, different devices exist to guard an individual who, for different reasons, is subject to a restriction of freedom.

For example, patients affected by dangerous infective pathologies have to be guarded so that the do not leave predetermined areas of an hospital, or individuals under police surveillance must be confined within a pre-designated location.

In fact, for the increasing overcrowding of jails and for reducing the high costs of maintenance of houses of confinement, financed by the government, it is common to sentence certain types of offenders to confinement within the offender's place of residence.

Therefore, the need is felt to guard individuals confined within their residence, guaranteeing that they remain in a predetermined area. To this end, devices exist for remotely guarding individuals confined within their residence, for detecting if they escape or tamper the devices, by exchanging information with a central unit.

These devices, comprising a sender that is secured to the wrist or to the ankle of the individual with a plastic belt, exchange signals with a computer, in turn connected to a telephonic line. If the individual leaves the confinement area, an alarm signal is generated. The same occurs if the individual tampers the plastic belt or the processor.

Presently, the known devices used for controlling individuals confined within their residence can only warn the central unit of a possible escape from the area of confinement, but are not capable of measuring the exact position of the escaped individual.

In addition, such devices cannot check whether the individual that should wear the device at the wrist or ankle, is really the individual under surveillance or another person helping him to escape.

Bracelet devices exist for controlling individuals that are associated to identity check systems, for example of biometric type. In WO0144836 a device is described where the individuals confined within their residence, in addition to wear a bracelet, must move periodically to a fixed computerized position and have their fingerprints scanned by a reader. However, this causes a fixed apparatus to be moved all the times the individual is moved, as well as it involves high apparatus costs. This solution, then, is suitable for being used within jails, for guarding individuals in particular areas, but not for those individuals confined within their residence.

### SUMMARY OF THE INVENTION

It is an object of the present invention to provide a method for detecting the position and the presence of an individual in a predetermined place for verifying immediately the identity thereof without the need of fixed local units.

These and other objects are achieved by the method for testing the presence and verifying the identity of an individual, according to the present invention, characterised in that it comprises:
receiving, by a bracelet unit that the individual wears, a verification signal sent by a central unit;
measuring within a predetermined time at least one biometric record of the individual directly by said bracelet;
detecting position data of the bracelet;
transmitting by the bracelet a set of signals of response comprising said biometric record, and said position data;
receiving by the central unit said set of signals and comparing with data previously stored.

The detection can be also provided of data of presence of the bracelet unit on the individual and/or data of tampering the bracelet.

According to the invention the biometric record can be a fingerprint, or an image of the retina, or a vocal wave file of the individual under surveillance.

In particular, the central unit delivers periodically to the bracelet unit a signal, at a predetermined frequency. Therefore, who wears the device, as instructed at the beginning, should have the fingerprints and/or the retina and/or the voice examined. The biometric record received is then compared with that stored in the database and corresponding to the same individual under surveillance.

The device that carries out the method according to the present invention provides a bracelet unit comprising:
means for receiving a verification signal sent by a central unit;
means for detecting at least one biometric record of the individual;
means for detecting position data of the bracelet;
means for transmitting the detected information to said central unit.

Means can be provided for detecting data of presence of the bracelet unit on the individual, and/or for detecting tamper of the bracelet.

The above described means are integrated in a module comprising a processor and a programmed EEPROM where the application and the main firmware are resident.

Advantageously, the means for detecting position data comprise a GPS device that processes satellite signals.

The means for detecting data of presence of the bracelet unit on the individual can comprise in combination or alternatively:
a sensor of heart beat,
a sensor of body temperature,
an underskin chip implanted in the individual under surveillance, associated to a system integrated in the bracelet that recognizes an identification code emitted by the underskin chip.

In a preferred embodiment, the device is elongated, parallelepiped shaped, with a central portion that comprises the means for receiving, detecting and transmitting and two side ends made of flexible material, preferably rubber-like, which can deform elastically for not impeding movement when wearing the device.

In particular, the central part of the device comprises at least a first sensor for detecting the fingerprints, a second sensor for controlling the heart beat and the temperature, a chip and a battery.

Alternatively, or in addition to the sensor for detecting the fingerprints, another device is provided of biometric detection.

In a first embodiment, the device of biometric detection is a scanner of the retina, which is available on the market. In this case, means can be provided for allowing the alignment of the eye, not described in detail.

In a second embodiment, the device of biometric detection is a microphone associated to a chip of voice recognition.

Preferably, the device, made of low allergenic material, is secured to the wrist or to the ankle or other part of the body of the individual, by means of a tamper resistant belt, in case the device is used, for example, for surveillance of individuals confined within their residence. Alternatively, this belt is provided with a normal closure mechanism, that can be easily opened.

A preferred embodiment of the device, according to the present invention, provides the following dimensions:
length set between 8 and 16 cm;
width set between 2 and 6 cm;
height set between 1 and 4 cm.

### BRIEF DESCRIPTION OF THE DRAWINGS

Further characteristics and the advantages of the method and of the unit according to the invention will be made clearer with the following description of an embodiment thereof, exemplifying but not limitative, with reference to the attached drawings, wherein:

FIG. 1 shows a diagrammatical view of the method for testing the presence and verifying the identity of an individual, according to the present invention;

FIGS. 2 and 3 show respectively a perspective view and a top plan view of a bracelet for testing the presence and verifying the identity of an individual, according to the present invention;

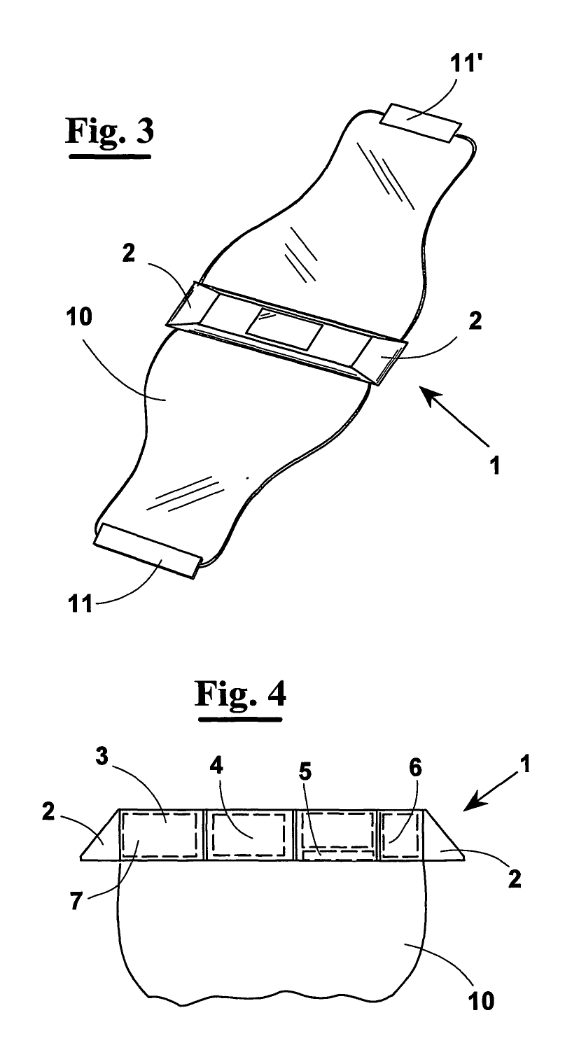

FIG. 4 shows an elevational side view of the apparatus diagrammatically cross sectioned for showing the apparatus inside;

FIGS. 5 and 6 show an exemplifying perspective view of the bracelet, according to the invention, secured to the wrist of an individual whose freedom is restricted;

FIGS. 7 and 8 show two flowsheets, for the detecting procedure respectively on board of the bracelet and in the central unit.

### DESCRIPTION OF A PREFERRED EMBODIMENT

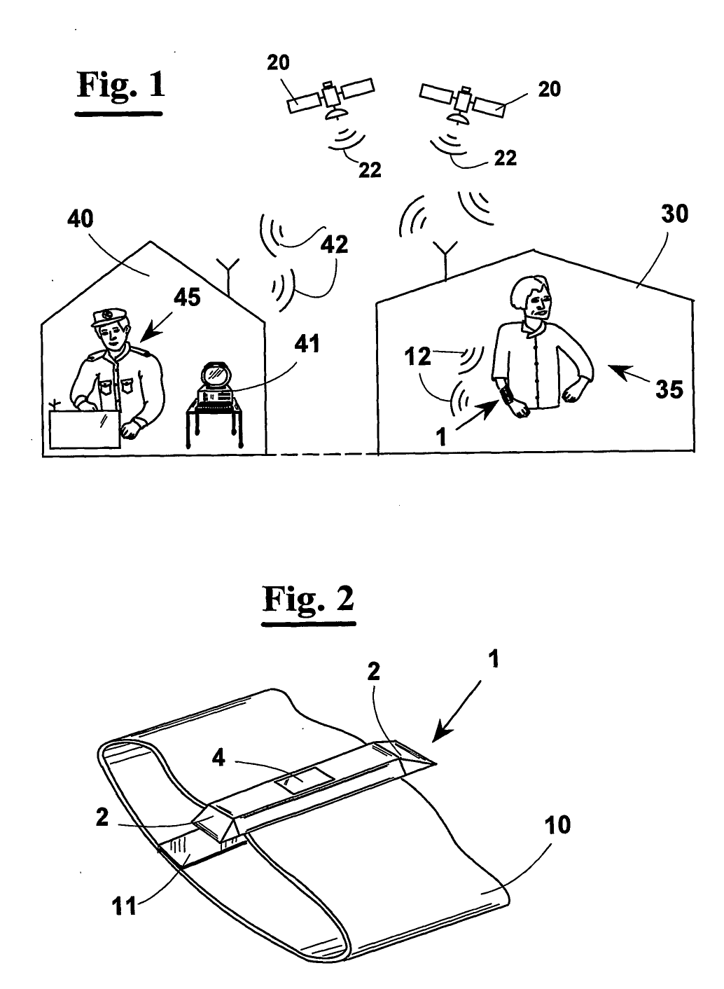

According to the invention, with reference to FIG. 1, a bracelet unit 1 for detecting the position and for confirming the identity of an individual 35 who wears it is equipped with a device for detecting a biometric record, in particular a fingerprint.

By using bracelet 1, for testing the presence and verifying the identity of individual 35, a step is provided of receiving, by bracelet 1, a verification signal 42 by a central unit 40, arranged with a computer 41. From that moment, individual 35 that wears bracelet 1 must put within a certain time a predetermined finger on the detection device, integrated to bracelet 1, which scans the fingerprint.

Before or after measuring the biometric record of individual 35 the position is detected of bracelet 1 and then of individual 35 by the GPS network, consisting of, as known, a plurality of satellites 20, which send position signals 22. Bracelet 1, in fact, analyses the satellite signals and produces a corresponding position signal. Furthermore, bracelet 1 produces a signal of presence, of known type, confirming that individual 35 is wearing it and has not tampered it.

Central unit 40 can be assisted by a guard 45 who, in addition to check that bracelet 1 is in the desired area, for example a house 30, verifies that bracelet 1 has not emitted signals of tamper. Furthermore, guard 45 checks the signal of presence of bracelet 1, proving that the individual is wearing it.

The latter signal can be obtained by a sensor of heart beat, or a sensor of body temperature, or it can be associated to an underskin chip implanted in the individual under surveillance. In this case, the bracelet recognizes an identification code emitted by the underskin chip.

The detection device on bracelet 1 can either directly analyse the biometric data or scan the biometric data that are transmitted as files to central unit 40 which computes them.

Figures from 2 to 4 show a possible embodiment of bracelet 1, according to the invention, having parallelepiped elongated shape, with two ends 2 of resilient material and a central portion 3 comprising the means for receiving the verification signal, for detecting the biometric record and for transmitting the data of presence.

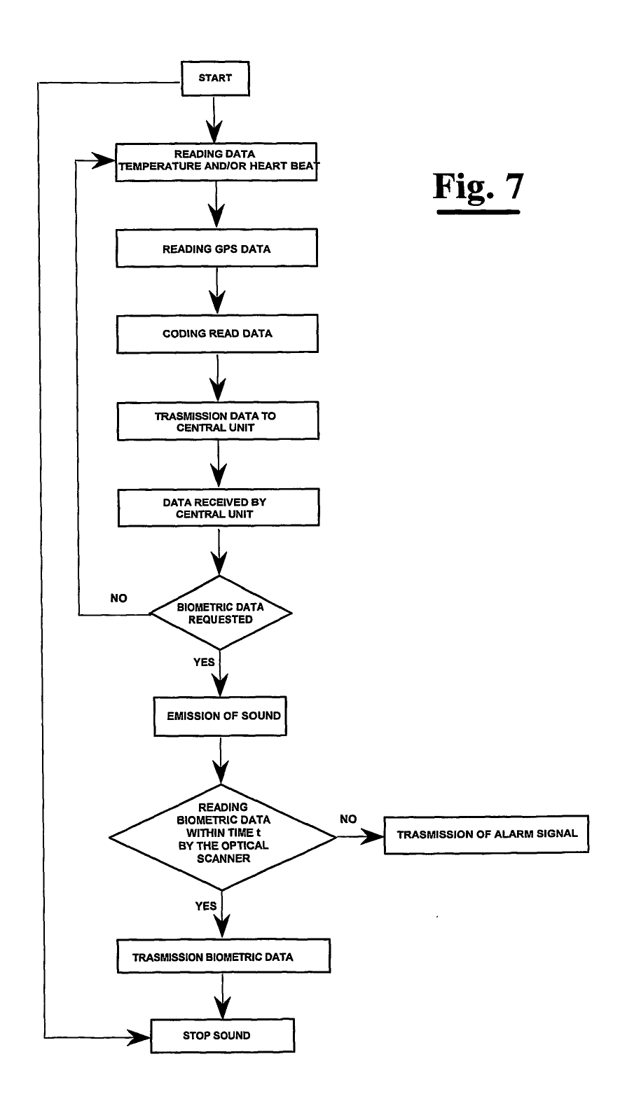

Bracelet 1 is secured to the wrist or to the ankle of individual 35 (FIGS. 5 and 6) by means of a belt 10, or wristlet, with a closure 11 that can be either with a lock or freely releasable, according to the kind of surveillance strategy.

The bracelet can also be put on the ankle, or can be made as different device for detecting the presence and checking the identity of the individual, i.e. configured for being put on in another way, for example by a belt, strap, or incorporated in a garment.

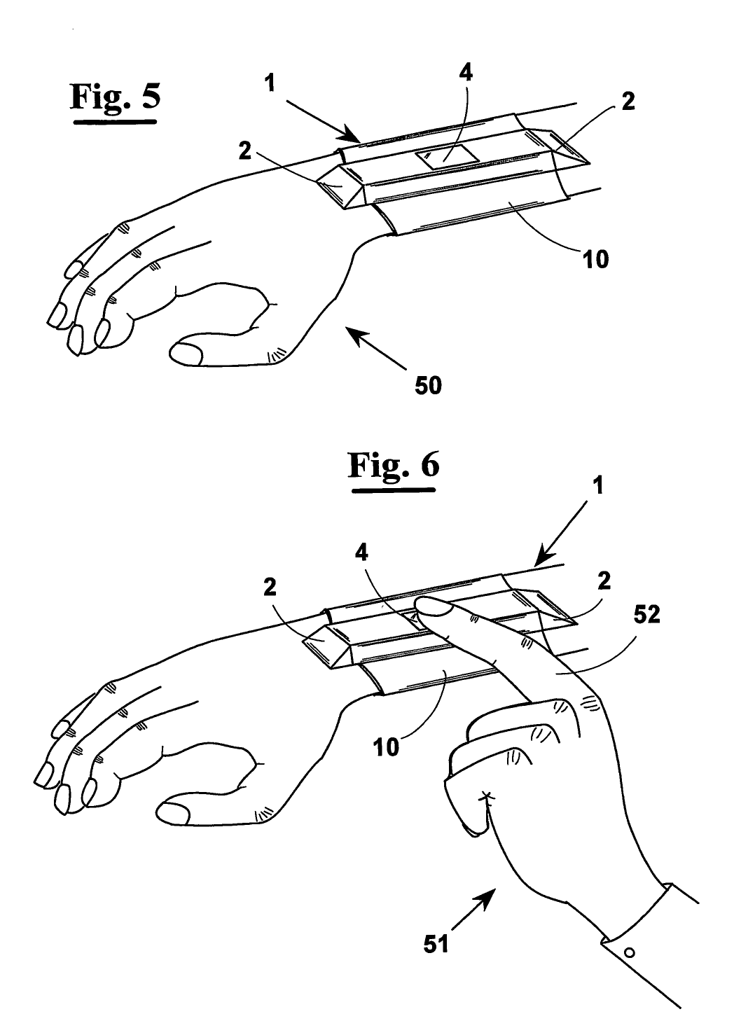

In particular, in FIG. 4 the means for receiving, controlling and transmitting the data are diagrammatically shown, comprising a chip 7, a sensor for detecting the biometric record 4, a sensor for analysis of the heart beat 5 and a battery 6.

In FIGS. 5 and 6 the steps are diagrammatically shown for scanning a finger 60, for example the index, owing to bracelet 1. Individual 35 wears bracelet 1, according to the invention, on a first arm 50 and, once received the verification signal 42 from central unit 40, puts the index 52 of second hand 51 on the means for detecting the biometric record 4 located on bracelet 1. Then, central unit 40 verifies the identity of individual 35 and proceeds as already specified.

The device of biometric detection 4 is a scanner of fingerprints available on the market, with miniaturized integrated circuit.

Alternatively, the device of biometric detection 4 is a scanner of the retina, which is also available on the market. In this case, means can be provided for allowing the alignment of the eye, not described in detail.

As further alternative the device of biometric detection 4 is a microphone associated to a voice recognition chip. In this case, more vocal sequences can be provided for, that are asked to the individual for being pronounced in order to carry out the recognition.

In the device above described hardware and software elements are resident implementable by a skilled person without difficulty. The logic of operation can be of “event-driven” type, i.e. operated as the events occur, for giving an image of the position, identity, etc., of the guarded individual responsive to the data provided by the bracelet and based on a behaviour model predetermined by the central unit. When a bracelet signals that it is not any more in a “normal or foreseeable” situation (mechanical malfunction, shock, etc.) the central unit is immediately informed updating the central monitoring unit.

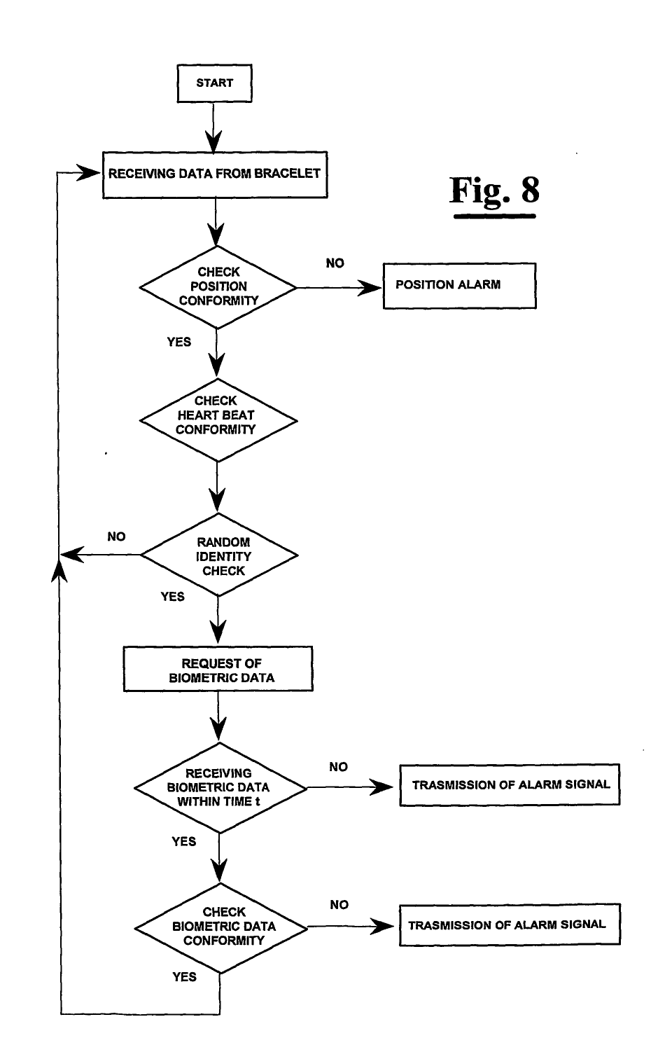

With reference to FIGS. 7 and 8, the software residing respectively in the bracelet and in the central unit provide a main routine, with continuous or discrete verification of the position of the bracelet and of the signal that the individual is wearing it. The verification of the biometric data, instead, is carried out by the central unit either randomly, or under manual demand of an operator at the central unit.

The central unit comprises a standard architecture with local ETHERNET ISO802.3 network. On this LAN the many computers are connected dedicated to particular functions: server of data base, of communication, of maintenance, workstations. The computers used are based on PC PENTIUM technology, with Windows NT operating system and Oracle Data base. The application software is written in proprietary language, and language SQL for access to the Oracle Data base.

The communication network that allows the exchange of data with the many bracelets distributed on the territory is made with intelligent units and communication sub networks: LAN—Local Area Network, at the Central unit; WArN—Wide Area radio Network at the mobile unit; SRRC—Short Range Radio Communication, at the mobile unit.

On this extended network a TCP/IP communication protocol is used, which defines the rules for exchanging messages and specifies the anomalies, all this independently by the network technology used for connecting physically the many computers. The WArN used is the cellular network GSM—SMS. The apparatus installed on the bracelets and the computer installed in the central unit are capable of exchanging data by the telephonic cellular network with SMS and Data Transfer technique.

The control unit monitors the many bracelets spread on the territory by controlling the GPS position data sent via the communication network (GSM, GPRS) by the hardware contained in the bracelet. The remote identification of the geographical data is immediately displayed by an icon on the digital maps of the examined territory and then with the exact position, i.e street and number, and overlapping the image of the examined area (orthophoto and/or satellite photo). Each icon returns the reference relative to the guarded individual, such as name and/or other.

The software of the geographical data can be installed both on Client-Server architecture and on Intranet or Internet network and equipped with various known functions such as: pan, zoom in, zoom out, query, etc.

The remote identification of the geographical data is unique, since each apparatus is characterised singularly by an identification key (Password) and by the system (Login).

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Method for testing the presence and verifying the identity of an individual, characterised in that it comprises the steps of:
receiving, by a bracelet unit that the individual wears, a verification signal sent by a central unit;
measuring within a predetermined time at least one biometric record of the individual directly by said bracelet;
detecting position data of the bracelet;
transmitting by the bracelet a set of signals of response comprising said biometric record and said position data;
receiving by the central unit said set of signals and comparison with data previously stored.

2. Method for testing the presence and verifying the identity of an individual, according to claim 1, wherein said biometric record can be chosen among a fingerprint, an image of the retina, a vocal wave file of the individual under surveillance.

3. Method for testing the presence and verifying the identity of an individual, according to claim 1, wherein the step is provided also of detecting data of presence of the bracelet unit on the individual and/or data of tampering the bracelet.

4. A bracelet unit for testing the presence and verifying the identity of an individual comprising:
means for receiving a verification signal sent by a central unit;
means for detecting at least one biometric record of the individual;
means for detecting position data of the bracelet;
means for transmitting the detected information to said central unit.

5. Unit according to claim 4, wherein said means for detecting at least one biometric record of the individual are chosen among, in combination or alternatively:
a device for detecting fingerprints;
a scanner of the retina, associated to means for aligning with the eye of the individual;
a microphone associated to a voice recognition chip.

6. Unit according to claim 4, wherein means are provided for detecting data of presence of the bracelet on the individual, and/or means for detecting tamper of the bracelet.

7. Unit according to claim 4, wherein said means for detecting position data comprise a GPS device that processes satellite signals.

8. Unit according to claim 4, wherein said means for detecting data of presence of the bracelet on the individual can comprise in combination or alternatively:
a sensor of heart beat,
a sensor of body temperature,
an underskin chip implanted in the individual under surveillance, associated to a system integrated in the bracelet that recognizes an identification code emitted by the underskin chip.

9. Unit according to claim 4, characterised by having parallelepiped elongated shape with a central portion that comprises said means for receiving, detecting and transmitting, and two sides ends made of flexible material.
